(19) United States
(12) Patent Application Publication
(10) Pub. No.: US 2008/0148921 A1
(43) Pub. Date: Jun. 26, 2008

(54) Article of manufacture for bass drum damping with variable physical and acoustical damping characteristics

(76) Inventor: John Wilson Calder, Minneapolis, MN (US)

Correspondence Address: JOHN WILSON CALDER, 3712 GARFIELD AVE. S., MINNEAPOLIS, MN, 55409-1115, US

(21) Appl. No.: 12/001,963

(22) Filed: Dec. 13, 2007

Related U.S. Application Data
(60) Provisional application No. 60/876,771, filed on Dec. 22, 2006.

(51) Int. Cl. G10D 13/02

(52) U.S. Cl. 84/411 M

(57) ABSTRACT

An article of manufacture for bass drum damping with variable physical and acoustical damping characteristics for the purpose of altering bass drum tonal qualities, with two different double-bevel end-shapes, different end-to-end lengths (accommodating standard manufactured bass drum depths) to allow complete end-shape contact with both drumheads simultaneously, dense processed recycled cotton acoustically absorbent main-body material for broadband frequency absorption, durable acoustically transparent open-weave poly mesh main-body covering material allowing maximum acoustical absorption, and rubber-like acoustically transparent end-shape covering material enabling increased contact point friction for reduced displacement while allowing maximum acoustical absorption.

### CROSS REFERENCE TO RELATED APPLICATIONS

This application is based on provisional application Ser. No. 60/876,771, filed on Dec. 22, 2006.

### STATEMENT REGARDING FEDERALLY SPONSORED RESEARCH OR DEVELOPMENT

Not Applicable

### DESCRIPTION OF ATTACHED APPENDIX

Not Applicable

### BACKGROUND OF THE INVENTION

This invention relates generally to the field of drums and more specifically to an article of manufacture for bass drum damping with variable physical and acoustical damping characteristics, for the purpose of altering bass drum tonal qualities.

The bass drum has been an integral part of popular music for many decades, and in the pursuit of better drum sounds, drummers, sound engineers, and others in the music business have used various tone-modifying methods to improve the sound of the bass drum. These include pillows, blankets, and other found items to reduce unwanted overtones and harmonics of the drum by applying pressure to the batter drumhead to dampen vibrations that result from the drumhead being struck by the bass drum pedal beater, and the sympathetic resonances occurring within the front, or resonant, head (when present).

As well as the attempts to use household and other randomly-available damping or muffling materials, a number of products have been introduced to accomplish drumhead damping or muffling, and they generally employ soft or semi-soft materials pressure-held or otherwise positioned against one of the drumheads (to dampen both drumheads, two such devices have been necessary, adding expense and setup complications). Examples of such products include U.S. Pat. Nos 5,107,741 and 5,233,898 as well as U.S. Pat. Nos. 4,745,839, 4,589,323, 4,338,850, and 4,154,137.

The present invention is more effective than found objects or previous devices at physically damping or muffling both drumheads at the same time, or alternately only one of the drumheads, as well as providing many different combinations of drumhead contact points, which can change the sound of the drum over a wider range of tonalities, and is more easily repositioned to effect those changes.

The present invention is importantly also an acoustical damper, utilizing a specialized dense processed recycled cotton acoustical absorbing material that will attenuate a much wider range of frequencies than found objects or previous devices, i.e. from approximately 200-20,000 Hz, with the most effective frequency absorption occurring in the 400-1,500 Hz range. This invention effectively attenuates the most unwanted overtone and harmonic frequencies of modern bass drums, and is especially effective for bass drums with deeper dimensions (measured from the batter drumhead to the front drumhead) due to the additional resonance and reflectivity of deeper drum shells. Previous to this invention, existing found objects, products, and devices attenuated only the high frequencies of the bass drum, i.e. from approximately 2,000-20,000 Hz, which did not attenuate the unwanted mid-range frequencies (i.e. the previously mentioned 400-1,500 Hz).

### BRIEF SUMMARY OF THE INVENTION

The primary object of the invention is to provide a novel physical bass drum damper containing two different double-bevel end-shapes to dampen the vibrations of one or both drumheads to achieve different sound qualities due to varying drumhead contact points and contact point combinations.

Another object of the invention is to provide novel different end-to-end lengths (accommodating various standard manufactured bass drum depths) to allow complete end-shape contact with both drumheads simultaneously.

Another object of the invention is to provide a novel method for easily and quickly repositioning the bass drum damper to achieve a variety of different drum sound qualities.

Another object of the invention is to provide a novel acoustical drum damper for the absorption of unwanted sounds in the form of mid-frequency overtones and harmonic ringing inside the drum shell by attenuating reflections and resonances.

A further object of the invention is to provide a novel method for absorbing sound inside the drum shell using dense recycled processed cotton acoustical absorption material with broadband sound absorption characteristics.

Yet another object of the invention is to provide improved drum damper main-body covering material of durable and acoustically transparent poly mesh to enable maximum acoustical absorption.

Yet another object of the invention is to provide improved drum damper end-shape covering material of acoustically transparent rubber-like material to enable maximum acoustical absorption as well as drumhead contact point friction.

Still yet another object of the invention is to provide an improved drum damper which is easily and inexpensively manufactured using existing materials.

Other objects and advantages of the present invention will become apparent from the following descriptions, taken in connection with the accompanying drawings, wherein, by way of illustration and example, an embodiment of the present invention is disclosed.

In accordance with a preferred embodiment of the invention, there is disclosed an article of manufacture for bass drum damping with variable physical and acoustical damping characteristics comprising: two different double-bevel end-shapes, different standard manufactured end-to-end lengths (accommodating standard manufactured bass drum depths) to allow complete end-shape contact with both drumheads simultaneously, dense processed recycled cotton acoustically absorbent main-body material, durable acoustically transparent open-weave poly mesh main-body covering material allowing maximum acoustical absorption, and rubber-like acoustically transparent end-shape covering material enabling increased contact point friction for reduced displacement while allowing maximum acoustic absorption.

### BRIEF DESCRIPTION OF THE DRAWINGS

The drawings constitute a part of this specification and include exemplary embodiments to the invention, which may be embodied in various forms. It is to be understood that in some instances various aspects of the invention may be shown exaggerated or enlarged to facilitate an understanding of the invention.

FIG. 1 is a top plan view of the drum damper in accordance with the preferred embodiment of the present invention;

FIG. 2 is a side elevational view of the drum damper shown in FIG. 1;

FIG. 3 is a perspective view of the drum damper shown in FIG. 1;

FIG. 4 is a side elevational view of the drum damper shown in FIG. 1 in place within a bass drum showing one option for drumhead contact, designated contact A;

FIG. 5 is a side elevational view of the drum damper shown in FIG. 1 in place within a bass drum showing another option for drumhead contact, designated contact B;

FIG. 6 is a top plan view of the drum damper shown in FIG. 1 showing another option for drumhead contact, designated contact C;

FIG. 7 is a top plan view of the drum damper shown in FIG. 1 showing another option for drumhead contact, designated contact D.

### DETAILED DESCRIPTION OF THE PREFERRED EMBODIMENTS

Detailed descriptions of the preferred embodiment are provided herein. It is to be understood, however, that the present invention may be embodied in various forms. Therefore, specific details disclosed herein are not to be interpreted as limiting, but rather as a basis for the claims and as a representative basis for teaching one skilled in the art to employ the present invention in virtually any appropriately detailed system, structure or manner.

### DRAWINGS REFERENCE NUMBERS

10. Drum damper
11. Main-body acoustical material
12. Main-body cover material
13. End-shape cover material
14. Front drumhead
15. Batter drumhead
16. Bass drum shell
17. Beater pedal
18. Main-body side bevel

### DETAILED DESCRIPTION OF THE INVENTION

In accordance with the the preferred embodiment of the present invention, FIG. 1 shows the drum damper 10 comprising main-body acoustical material 11, with two different end-shapes with end-shape cover material 13, and main-body covering material 12. The drum damper 10 dimensions are as follows: main-body width approximately 6 inches; main-body height approximately 5.5 inches, depending on the thickness as supplied of the main-body acoustic material 11 (this may vary slightly due to the recycled nature of said material); main-body length is dependent on bass drum depth (internal head-to-head measurement), standard end-to-end lengths are approximately 14.4″, 16.4″, or 18.4″ (to accommodate corresponding standard manufactured bass drum depths of 14″, 16″ and 18″); any drum depth may be accommodated by adding approximately 0.4″ to the drum's internal head-to-head dimension. The width and height dimensions may be altered to obtain more or less acoustical absorption, or to accommodate different manufacturing efficiencies or methodologies. The drum damper 10 is shown in contact with both front drumhead 14 and batter drumhead 15; this is one of several drumhead contact point options. The durable, open-weave acoustically transparent poly mesh main-body cover material 12 allows sound to be absorbed by the dense processed recycled cotton main-body acoustical material 11. The main-body cover material 12 is glued together at its'overlapping longitudinal seam, but it is not glued to the main-body acoustical material 11, as this glue would impede acoustical absorption. The rubber-like acoustically transparent end-shape cover material 13 also allows sound absorption, as well as providing increased friction with the drumhead to reduce drum damper 10 movement or displacement from the selected placement. The end-shape cover material 13 is glued to the main-body cover material 12 at all edge overlap seams and likewise is not glued to the main-body acoustical material 11.

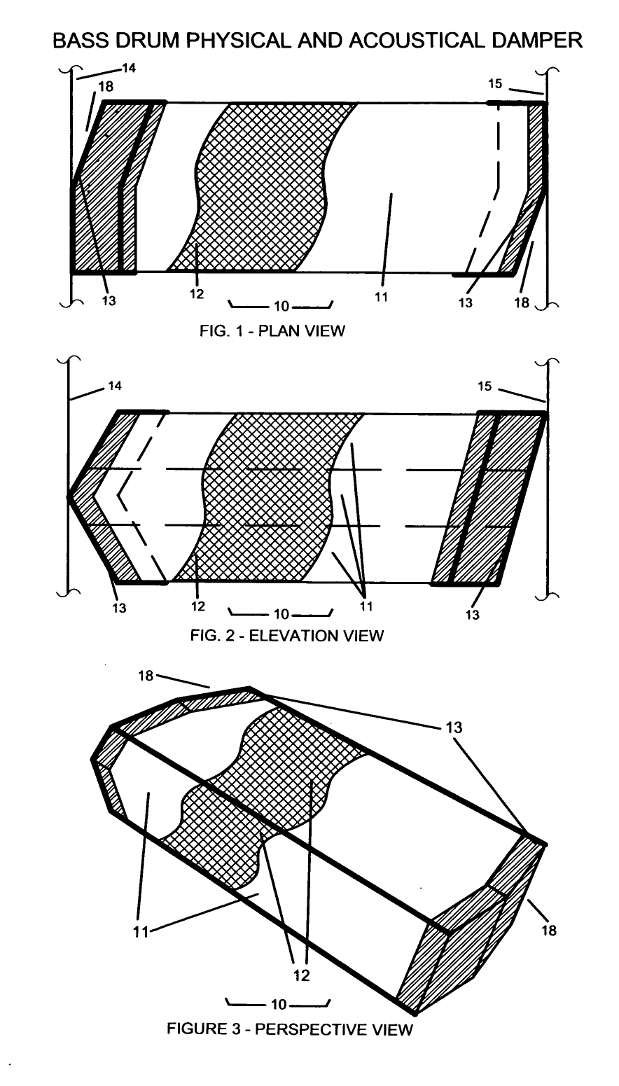

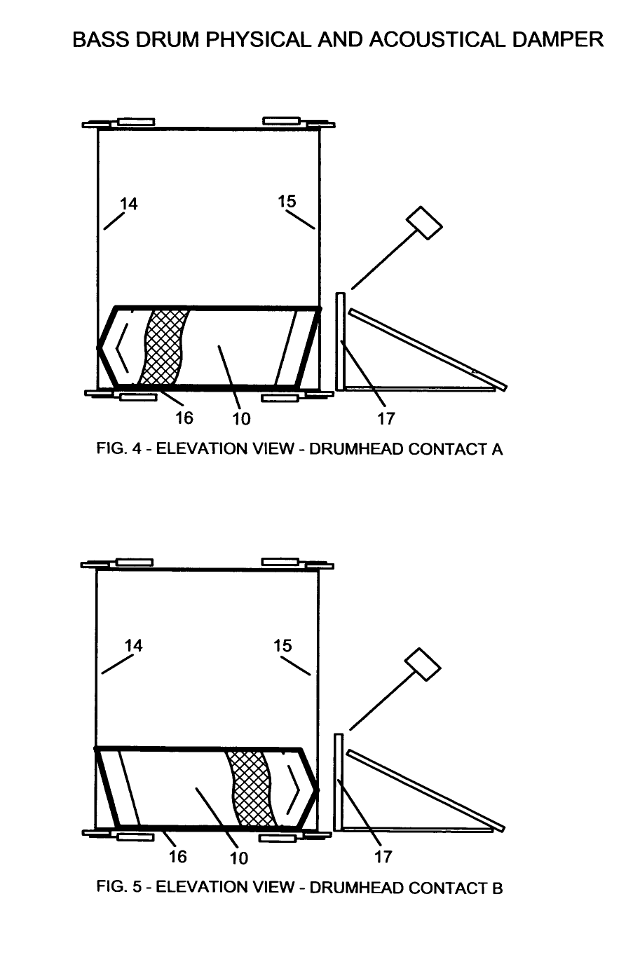

As shown in FIG. 2, in side elevational view one of the end-shapes resembles a “chisel”-shaped contact point and the other end-shape resembles an “arrow”-shaped contact point, each of which serve to dampen the drumhead at a different contact point due to the different distances of the drumhead contact points from the outer edge of the drumhead with drum damper 10 in its' preferred position at the bottom of the bass drum shell 16 (see also FIG. 4 and FIG. 5). These changes in drum sound by damping the drumhead at different contact point distances from the edge of the drumhead are due to the differing harmonic content which occurs at different annular drumhead edge distances. FIG. 2 also shows the layers of main-body acoustical material 11 which increase the absorbent qualities of the material due to increased thickness. These layers are glued together for forming during manufacturing; however, layers are glued lightly to allow sound absorption throughout the main-body acoustic material 11.

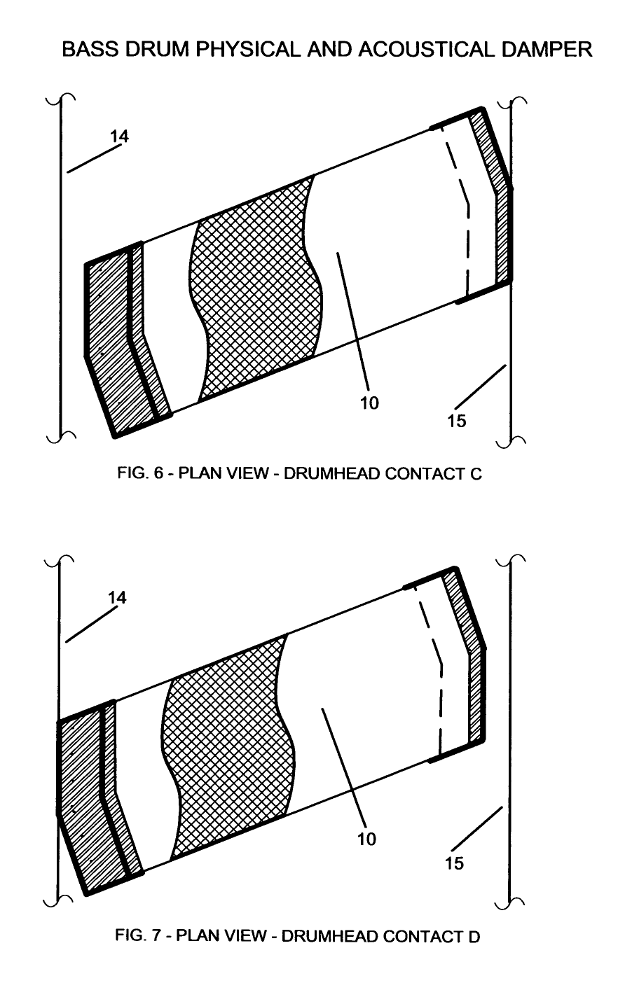

As shown in FIG. 3, the double angles formed by the “chisel” shape and the “arrow” shape in combination with each main-body side bevel 18 (also shown in FIG. 1) allow various physical drumhead contact points to be chosen depending on the desired amount and preferred characteristics of drumhead damping (see also FIG. 6 and FIG. 7). As can be seen in FIG. 3, the end-shape cover material 13 completely covers the end-shape surfaces and overlaps the main-body cover material 12. Both main-body cover material 12 and end-shape cover material 13 are acoustically transparent which allows maximum sound absorption at all frequencies from approximately 200-20,000 Hz by main-body acoustical material 11. The dense processed recycled cotton main-body acoustical material 11 may be substituted for with either compressed acoustic fiberglass, which is considered unsafe for this application (due to the “shedding” of dangerous fiberglass particles when the bass drum is struck) and is difficult to accurately form, or with open-cell (also called “acoustic”) foam, which has less acoustical absorption over a narrower frequency range (approximately 2,000-20,000 Hz) and is therefore much less effective at the broadband sound absorption critical to obtaining the desired bass drum sound.

Referring now to FIG. 4, there is shown a bass drum shell 16 with front drumhead 14 and batter drumhead 15 with the drum damper 10 within and resting on the bottom of said shell and fully contacting both drumheads. In this way, both drumheads are damped, each at a different contact point height. This configuration is designated as drumhead contact A, and is one of the options for changing the sound of the drum. Repositioning the drum damper 10 for different drum sound options (see FIG. 5, FIG. 6, and FIG. 7) can be accomplished easily and quickly with this invention, as most front drumheads in current use have 4″-6″ diameter circular holes (also known as “sound ports”) to allow microphone placement within the drum. This allows access to drum damper 10 in order to easily change its' placement and consequently the drum sound. This advantage is in effect for all drum damper 10 placement choices. Said drum damper may be securely fastened to said drum shell with commercially available hook-and-loop fastener strips or with commercially available double-adhesive tape strips.

As can be seen in FIG. 5, the drum damper 10 has been placed within the bass drum shell 16 with reversed end-shape contact points from FIG. 4, designated as drumhead contact B. This placement likewise provides for both drumheads to be damped simultaneously. As the contact points are at different heights from those shown in FIG. 4, the sound of the drum is changed. This is due to the inherent differences in each drumhead's sound as a function of whether the drumhead is struck (batter drumhead 15) or resonates sympathetically with the struck drumhead (front drumhead 14). By selectively damping each drumhead at differing heights, the annular vibrations in that head will be damped differently, leading to various drum sound options.

To accomplish an important function of the invention, there is shown in FIG. 6 a top plan view of the drum damper 10 in full contact with the batter drumhead 15 but having no contact with the front drumhead 14, designated as drumhead contact C. This illustrates the function of the main-body side bevel(s) 18, which is to provide a method for fully damping only one or the other of the two drumheads (front and batter) mounted on a typical bass drum. These bevels allow the drum damper 10 to be positioned at an angle so that the contact point on either single drumhead is the same as the contact points available on both drumheads when dampened simultaneously. A curve shape could be substituted for said bevel angle shape, however the curved shape surface would not have the same contact point area available as that of the bevel angle shape and therefore would not dampen a drumhead as effectively.

To further illustrate this important function of the invention, there is shown in FIG. 7 a top plan view of the drum damper 10 in full contact with the front drumhead 14 but having no contact with the batter drumhead 15, designated as drumhead contact D, again highlighting the function of the main-body side bevel(s) 18, which is to provide a method for fully damping only one or the other of the two drumheads, in this case the opposite drumhead from that shown in FIG. 6. A further option of no drumhead contact whatsoever allows only acoustical damping of the bass drum sound, which is accomplished by the horizontal rotation of drum damper 10 away from any drumhead contact and this option takes advantage of the inherent broadband acoustical absorption of this invention.

While the invention has been described in connection with a preferred embodiment, it is not intended to limit the scope of the invention to the particular form set forth, but on the contrary, it is intended to cover such alternatives, modifications, and equivalents as may be included within the spirit and scope of the invention as defined by the appended claims.

What is claimed is:

1. An article of manufacture for bass drum damping with variable physical and acoustical damping characteristics, for the purpose of altering bass drum tonal qualities, comprising:
two different double-bevel end-shapes;
different end-to-end lengths (accommodating standard manufactured bass drum depths) to allow complete end-shape contact with both drumheads;
a main-body consisting of dense processed recycled cotton acoustically absorbent material;
a durable acoustically transparent open-weave poly mesh main-body covering material allowing maximum acoustical absorption; and
a rubber-like acoustically transparent end-shape covering material enabling increased drumhead contact point friction for reduced displacement while allowing maximum acoustical absorption.

2. The drum damper of claim 1, wherein:
main-body cross-section dimensions enable efficient manufacturing with existing dense processed recycled cotton acoustically absorbent material dimensions;
double end-shape bevel angles enable simple two-step cutting process for manufacturing; and
end-shape covering material overlaps with main-body covering material to provide increased friction with bass drum shell to reduce said drum damper displacement.
